(19) United States
(12) Patent Application Publication
(10) Pub. No.: US 2023/0191921 A1
(43) Pub. Date: Jun. 22, 2023

(54) SOIL-COMPACTING MACHINE HAVING AN ELECTRIC MOTOR AND METHOD FOR OPERATION

(71) Applicant: BOMAG GmbH, Boppard (DE)

(72) Inventors: Timo Kirst, Boppard (DE); Bjorn Hammen, Boppard (DE); Markus Wolfram, Boppard (DE)

(21) Appl. No.: 17/600,269

(22) PCT Filed: Mar. 27, 2020
(86) PCT No.: PCT/EP2020/000077

§ 371 Date: Mar. 10, 2022

(30) Foreign Application Priority Data
Apr. 3, 2019 (DE) 10 2019 002 439.7

(51) Int. Cl. B60L 50/60; B60L 7/10; E02D 3/026

(52) U.S. Cl. CPC B60L 50/60; B60L 7/10; E02D 3/026; B60L 2200/40

(57) ABSTRACT

The present invention relates to a ground compaction machine for compacting a ground, in particular a tandem roller, a single-drum roller, a rubber-wheeled roller or a trench roller, comprising a machine frame, at least one travel unit with a wheel or a roller drum, a travel drive for driving the travel unit, and a steering drive for adjusting the traveling direction of the ground compaction machine, the ground compaction machine comprising at least one electric motor. The present invention also relates to a method for operating a ground compaction machine.

### CROSS-REFERENCE TO RELATED APPLICATIONS

The present application is a U.S. National Stage entry under 35 U.S.C. § 371 of, and claims priority to, International Application No. PCT/EP2020/000077, filed Mar. 27, 2020, which claims priority to DE102019002439.7, filed Apr. 3, 2019, the disclosures of which are hereby incorporated herein by reference in their entireties.

### FIELD OF THE INVENTION

The present invention relates to a soil or ground compaction machine for compacting a ground, in particular a tandem roller, a single-drum roller, a rubber-wheeled roller or a trench roller. Moreover, the present invention relates to a method for operating a ground compaction machine.

### BACKGROUND OF THE INVENTION

Generic ground compaction machines are mainly used in road and pathway construction, as well as in the construction of public squares or runways at airports, for example. They usually have a machine frame and at least one travel unit. The travel unit may typically comprise at least one roller drum with which the ground compaction machines roll over and compact the ground during working operation. The outer circumferential surface of the roller drum may be smooth or also structured, as is usual with so-called crusher drums, which are used, for example, for crushing rock. In addition to roller drums, rubber wheels are also used to compact the ground, and in the case of rubber wheels, the elastic deformability produces a kneading and rolling effect, which, in particular, brings about pore closure on the ground surface. To drive the travel unit, ground compaction machines may typically comprise a travel drive, such as a hydraulic motor that rotates the roller drum or wheel. Typical ground compaction machines are articulated-steered or pivot-steered and also have a steering drive to adjust the traveling direction of the ground compaction machine. The steering drive is typically also a hydraulic actuator that implements the control commands entered by an operator, for example via a steering wheel or joystick. It is also known to equip generic ground compaction machines with a vibratory drive that vibrates the roller drum or wheel to increase compaction performance. The corresponding vibratory drives are typically also hydraulically operated.

In order to provide any drive energy at all on generic ground compaction machines for operating the machine and, in particular, the hydraulic components, an internal combustion engine is typically used. These are mostly diesel combustion engines that provide the necessary energy to operate all other components of the ground compaction machines. An alternator, which is also driven by the combustion engine, is typically used to operate smaller electrical or electronic components, such as lighting equipment or the on-board computer.

However, the disadvantages of operating the ground compaction machines through a diesel combustion engine have recently become more and more apparent with the increasing demands on environmental and working conditions. For example, due to the pollutants emitted by diesel engines, ground compaction machines are subject to increasingly stringent environmental regulations. In addition, the high noise emission of combustion engines is also increasingly perceived as unpleasant. The generally poor efficiency of internal combustion engines and the high fuel consumption, which is exacerbated, for example, by the fact that it is not always possible to operate internal combustion engines at their optimum power point, are also problems that the manufacturers of modern ground compaction machines are facing.

Against this prior art background, one aspect of the present invention is to provide a ground compaction machine and a method for operating a ground compaction machine that are more economical than before. In particular, the aim is to increase efficiency and reduce fuel consumption, noise emissions and the emission of pollutants.

### SUMMARY OF THE INVENTION

Specifically, in a ground compaction machine as described at the beginning, one aspect of the present invention is achieved by the fact that it may comprise at least one electric motor. For example, the electric motor according to the present invention may be used to drive one or more hydraulic pumps, which in turn drive hydraulic motors. In this way, hydraulic motors, for example of the travel drive, the steering drive or a vibratory drive, can be driven indirectly by the electric motor. In other words, the at least one electric motor is configured to drive the travel drive and/or the steering drive and/or the vibratory drive. This can be done indirectly, for example, by driving a hydraulic pump. The electric motor itself is driven, for example, by an internal combustion engine, such as a diesel internal combustion engine, which in turn drives a generator. The generator converts the drive energy from the combustion engine into electric energy, which is either used directly to drive the electric motor or is temporarily stored in an electric energy storage device, such as an accumulator or battery. In one embodiment, the electric energy is temporarily stored in an electric energy storage device. In this case, the combustion engine can be operated constantly at its optimum power point to run the generator. Fluctuations in the energy consumption of the electric motor depending on the operating situation of the ground compaction machine are compensated by the electric energy storage device. In this way, the amount of fuel required by the internal combustion engine can already be significantly reduced, since the internal combustion engine does not have to be constantly operated in different speed ranges.

Alternatively, according to one embodiment of the present invention, the ground compaction machine is configured without an internal combustion engine. That is, the ground compaction machine does not have an internal combustion engine. The electric motor, which drives one or more hydraulic pumps to operate the other machine components, for example, is powered from an electric energy storage device, such as an accumulator or battery. As described earlier, the electric motor is used to drive other components of the ground compaction machine, such as hydraulic loads. For this purpose, the electric motor in turn drives one or more hydraulic pumps, which operate one or more hydraulic motors. These in turn operate the travel drive and/or the steering drive and/or the vibratory drive of the ground compaction machine, as well as other components if necessary.

According to another alternative embodiment of the present invention, the travel drive and/or the steering drive comprise an electric motor and are operated exclusively electrically. In addition, the ground compaction machine may also comprise a vibratory drive configured to excite a vibration at the wheel or roller drum, the vibratory drive comprising an electric motor and being operated exclusively electrically. Thus, in these embodiments, the locomotion of the ground compaction machine via the travel drive and/or the adjustment of the traveling direction of the ground compaction machine via the steering drive and/or the vibration of the wheel or roller drum are accomplished by an electric motor and not by a hydraulic motor as described above. The respective electric motor is therefore used directly for the rotation and/or vibration or directional adjustment of the wheel or roller drum. Thus, the travel drive and/or the steering drive and/or the vibratory drive of the ground compaction machine do not require hydraulics. The drive system for the travel drive and/or the steering drive and/or the vibratory drive is thus, in particular, configured to be fully electric.

According to another embodiment of the present invention, the entire ground compaction machine is configured such that it can be operated exclusively electrically via electric motors. Therefore, it does not include an internal combustion engine, nor a hydraulic system, and therefore deviates from the usual design. The corresponding ground compaction machine according to one embodiment of the present invention thus has no internal combustion engine, hydraulics or a hydraulic system. All components of the ground compaction machine that require a drive are operated by an electric motor, in particular, for example, the travel drive, the steering drive and the vibratory drive. In particular, these each have their own electric motor, which are supplied with electric energy from an electric energy storage device. By dispensing with an internal combustion engine, the ground compaction machine according to an exemplary embodiment of the present invention does not produce any pollutant emissions. In addition, a significant noise reduction is achieved. By using electric motors, a higher efficiency is achieved, so that less nominal power is required. In addition, the variety of parts of the machines is reduced, especially when additionally dispensing with a hydraulic system, so that both the manufacture and the maintenance of the ground compaction machines according to the present invention are significantly cheaper. Service activities such as oil or filter changes are no longer necessary. The gained engine space can be used almost exclusively as storage space for accumulators/batteries, allowing long working hours and/or a more compact machine design.

Accumulators or batteries are particularly suitable as electric energy storage devices. Rechargeable electric energy storage devices, in particular accumulators, are particularly preferred in one embodiment. For example, the electric energy storage device may be a lithium-ion accumulator or a nickel-metal hydride (NiMH) accumulator.

It is particularly advantageous if the electric energy storage device is configured and also arranged on the ground compaction machine in such a way that it can be replaced in just a few steps and, in particular, without tools. Without tools means that at least one fastening device is provided for securing the position of the respective energy storage device, which can be released and fixed exclusively manually. For this purpose, special slots are provided on the ground compaction machine, for example, where the electric energy storage device or devices, which are provided with complementary connectors, can be easily inserted and contacted.

The electric energy storage device or devices, in particular battery packs, may be configured as replaceable modules having an individual maximum weight of 15 kg, in particular a maximum weight of 10 kg. This ensures that the individual modules can be conveniently replaced manually at the machine and can also be transported to and/or away from the machine without special aids.

Generally, the electric motor of the vibratory drive may be located at any desired position on the ground compaction machine. For example, the electric motor may be connected via a gearbox to a vibration exciter arranged inside the wheel or roller drum and drive it from outside the wheel or roller drum. According to one embodiment of the present invention, however, the entire vibratory drive with the electric motor is arranged inside the wheel or roller drum. In this manner, only electric energy, for example via a cable, needs to be introduced from the outside into the inside of the wheel or roller drum in order to operate the electric motor of the vibratory drive. The latter in turn sets the vibration exciter into rotation, which causes the vibrations. In this manner, the otherwise unused space inside the wheel or roller drum can be utilized.

During working operation of the ground compaction machine, the vibration, and thus the vibratory drive, is regularly switched on and off. Rotating imbalance masses are usually used as vibration exciters. These imbalance masses usually take a long time to coast down after they are switched off, which is perceived as a disadvantage. It is therefore possible that a recovery system is provided for the energy stored in the rotating imbalance masses, which on the one hand improves the energy balance of the ground compaction machine and on the other hand leads to a faster standstill of the vibration exciter after it is switched off. Such a recovery system may be, for example, a hydraulic energy storage device, especially in the case of a hydraulic vibratory drive, which is filled with pressurized hydraulic fluid by the imbalance masses coasting down and in this manner recovers hydraulic energy. Alternatively, the vibratory drive may comprise an electric brake configured to shorten the coast-down time of the vibratory drive and to recover electric energy during braking. This can be realized, for example, by the electric motor acting as a generator after the vibratory drive is switched off, converting the rotational energy stored in the rotating vibrating masses into electric energy and feeding it into the electric energy storage device, for example. In this manner, energy is extracted from the vibration exciter, which thus comes to a standstill more quickly. At the same time, in both the hydraulic and the electric case, the energy thus obtained is available for reuse, for example when starting the vibratory drive, which not only makes operation more economical but also protects the environment.

In an alternative embodiment, the electric brake comprises a capacitor configured such that it is chargeable during braking and the stored energy can be used to start the vibratory drive. Particularly when switching on the vibratory drive, greater forces are required to set the imbalance masses of the vibration exciter into rotation from a standstill. Power peaks are therefore regularly demanded from the system in these cases. To provide the necessary energy during these power peaks, a capacitor can be used which is charged when the vibratory drive is switched off by using the electric motor as a generator. When the imbalance masses of the vibration exciter start up, the energy stored in the capacitor is then used to compensate for the power peak, so that smooth operation is achieved overall.

Generally, all suitable prior art electric motors may be considered for the present invention. They may be, for example, asynchronous motors or synchronous motors. However, synchronous motors are preferred due to their smaller size. In addition, water-cooled electric motors are preferred over air-cooled ones because the water-cooled electric motors are up to three sizes smaller than air-cooled ones. Overall, it is therefore possible that the at least one electric motor, in particular all electric motors, is a synchronous motor and/or has water cooling.

In particular, in cases where the internal combustion engine and/or the hydraulic system are dispensed with, spaces conventionally used by these components are made available on the ground compaction machine. Advantageously, these can be used, for example, to accommodate the electric energy storage device for supplying electric energy to the electric motor or motors. For example, dispensing with the internal combustion engine makes space available in the engine compartment that can be used to accommodate an electric energy storage device. To increase the possible uninterrupted working time of the ground compaction machines, the ground compaction machine may have more than one electric energy storage device. In order to make optimum use of the available installation space on the machine, the multiple electric energy storage devices may also have different sizes and be arranged at different positions, for example. A combination of replaceable, in particular without tools, and permanently installed energy storage devices may also be provided. According to one embodiment of the present invention, the ground compaction machine thus comprises at least two electric energy storage devices, which are arranged separately from each other at different positions on the ground compaction machine. For example, a plurality of electric energy storage devices of different sizes may be provided which are arranged wherever installation space is available. Due to the different sizes of the electric energy storage devices used, it is also possible to make optimum use of different sizes or small free spaces. In the case of accumulators/batteries, for example, the size of the electric energy storage device refers to both the size and the number of cells (secondary cells). For example, individual cells may also be installed as electric energy storage devices. In addition, individual cells may have different shapes or may be combined in various forms to form a larger electric energy storage device. In this manner, the shapes of the electric energy storage devices can be adapted to the respective conditions of the available installation space, which is thus used as fully and optimally as possible. Particularly, the ground compaction machine thus may comprise at least two separate energy storage devices or at least two separate modules which are shaped differently from one another and/or have a different storage capacity. These at least two energy storage devices, which are separate from one another, may also be arranged at different positions in the ground compaction machine, in particular without physical contact with one another.

During operation of ground compaction machines, strong vibrations and shocks usually occur. Although the wheels or roller drums are usually vibrationally decoupled from the rest of the ground compaction machine, the vibrations of the travel units are transmitted at least slightly to the rest of the ground compaction machine, especially when being set into vibration. To prevent such shocks and vibrations from damaging the electric energy storage devices, the electric energy storage devices may be configured to be shock-resistant. Moreover, the electric energy storage devices may be arranged or mounted on the ground compaction machine in a shock-resistant or vibration-damped manner. For example, the energy storage device or devices may be attached to the machine via a damping element, such as a rubber buffer. In particular, a support frame may be included which is mounted on the machine frame via damping elements and is vibration-damped relative to the machine frame by the damping elements. This support frame may be used to hold and store at least one energy storage device. All energy storage devices of the ground compaction machine may be mounted on the machine frame in a vibration-damped manner via at least one such support frame.

Especially in the roller drums of the ground compaction machine, a large part of the available space is usually unused. Therefore, according to one embodiment of the present invention, at least one electric energy storage device may be arranged inside a wheel or a roller drum. “Inside a roller drum” means that the electric energy storage device is located in the interior of the roller drum, for example between the two discs closing off the roller drum to the outside along its longitudinal direction. Especially in the case of shock-resistant energy storage devices, such an arrangement is not a problem, even if the corresponding roller drum is vibrated by a vibration exciter. If the ground compaction machine has two roller drums, an electric energy storage device may be arranged in each of the two roller drums.

Soldered connections represent a particular risk point for damage, especially due to vibrations. Soldered connections are necessary to make electric contacts between different components, in particular between individual cells of the electric energy storage devices or the electric energy storage devices and electrical lines, for example to the electric motors. Therefore, according to one embodiment of the present invention, soldered connections of electric contacts, in particular for contacting the electric energy storage devices or their cells among each other, comprise an elastic solder. Such an elastic or flexible solder is characterized by the fact that its elasticity enables it to withstand even strong and continuous vibrations without being destroyed. Flexible solders are therefore much better suited for use on ground compaction machines with vibratory drives than conventional solders, which withstand the typical stresses in the work process of ground compaction machines only for a short time and wear out or break up relatively quickly. The use of a flexible or elastic solder significantly increases the service life of soldered connections and improves the special application in ground compaction machines with vibratory drive. Additionally or alternatively, the individual cells of an electric energy storage device may be connected by means of elastic contacting elements to a printed circuit board which implements the electrical connection of the cells. Such elastic contacting elements may, in particular, have a composition of at least one elastic polymer and particles of a current conducting material. The connected cells then form the electric energy storage device. Optionally, a flexible solder may also be used for this purpose, which then serves as an elastic contacting element. This technology is used, for example, in the CONCHIFERA system manufactured by Invenox GmbH in Garching, Germany. The present invention also extends to the use of such electric energy storage devices, in particular according to the CONCHIFERA system, in a ground compaction machine.

Moreover, the present invention provides various embodiments for charging the electric energy storage devices. As already described, an internal combustion engine driving a generator may be used for this purpose, for example. However, it is possible to dispense with the internal combustion engine completely. According to one embodiment, for example, solar cells may used to charge the electric energy storage device. For this purpose, for example, a unit of mobile solar panels may be provided which are set up at the construction site separately from the ground compaction machine and serve as a charging station for the ground compaction machine and, in particular, the electric energy storage devices. Moreover, solar cells may also be arranged on the ground compaction machine itself, in particular on the outer surface of the ground compaction machine, such as the roof of the operator platform and/or on the hood or bonnet. According to one embodiment of the present invention, solar cells are thus provided, in particular on the roof of an operator platform and/or on a hood of the ground compaction machine, which are configured to charge the at least two electric energy storage devices. The solar cells on the ground compaction machine itself may be used throughout the working operation, as long as this takes place in daylight, to charge the electric energy storage devices and thus extend the maximum working time of the ground compaction machine before a separate charging process or replacement of the electric energy storage devices must be performed.

Both additionally and also as an alternative, a connector may be provided which is configured to allow an external power source to be connected to the ground compaction machine. Thus, the ground compaction machine itself comprises the connector, which may be in the form of a socket or a charging cable, for example. The connector is configured such that the ground compaction machine can be contacted, for example, with a power cable connected to the general power grid. For example, the ground compaction machine may be charged via a power cable or may even be operated directly via the power cable. This is particularly advantageous when compacting ground inside a building, for example, in a hall. Power cables are typically available in this environment and may be used for the entire work process. Moreover, it is possible to have a charging station that can be electrically contacted with the connector on the ground compaction machine. For example, the charging station may be connected to the general power grid or may include, for example, a generator driven by an internal combustion engine. The connector of the ground compaction machine and the charging station are configured such that they can be contacted easily and in a few steps, so that the ground compaction machine or at least one of the electric energy storage devices can be charged with electric energy by the charging station. The present invention therefore also extends to an operating unit comprising a ground compaction machine and such a charging station.

Additionally or alternatively, an energy source, in particular a mobile one, such as a fuel cell, may also be provided, which is configured to charge the at least two electric energy storage devices. The electric energy storage devices are therefore charged via a hydrogen fuel cell using the energy stored in the hydrogen, making them both highly efficient and particularly environmentally friendly. In particular, a mobile charging station is provided that includes the fuel cell and a hydrogen tank, and is contactable with either at least one of the electric energy storage devices or the ground compaction machine itself for charging. For example, the mobile charging station with the fuel cell may also comprise a travel unit for easier transport and a protective structure to protect the fuel cell and/or hydrogen tank from the weather and/or vandalism. In addition to the mobile charging station with a fuel cell, however, other energy sources may also be provided in the charging station. Conceivable energy sources include liquefied petroleum gas, methane, or other fossil or synthetic fuels. Moreover, the charging station may comprise solar cells or a generator which comprise, for example, an internal combustion engine or is wind- or water-powered. The present invention therefore also extends to an operating unit comprising a ground compaction machine and such a charging station. Such a solution brings with it the great advantage of being emission-free, or at least CO₂-free, throughout, for both charging and working operations.

The concept described above is particularly suitable for so-called lightweight tandem rollers, especially lightweight ride-on tandem rollers. Such rollers are characterized first of all by the fact that they have a total weight of less than 5 t. At the same time, such rollers may have a front frame and a rear frame that are steerably connected to each other via an articulated joint. An operator platform may be arranged on the rear carriage. On the front carriage, on the other hand, the at least one electric energy storage device may be positioned, ideally concealed under a swing-open hood to allow easy access and at the same time an aesthetic design together with mechanical protection. Such tandem rollers have at least one drum, typically on the front carriage, and at least one further drum or rubber wheel set on the rear carriage, typically comprising three or more rubber wheels arranged coaxially with one another. According to one embodiment of the present invention, an electric energy-conducting transmission connection is provided across the articulated joint connecting the front carriage to the rear carriage.

In particular, for such lightweight tandem rollers, it is possible if the at least one electric energy storage device is arranged at least partially in a region below the maximum vertical height of the at least one drum, in particular of both drums. This is made possible by the fact that the at least one electric energy storage device, particularly in the case of a multi-cell structure, can be brought into comparatively complex three-dimensional shapes and can thus be adapted, in particular, to installation spaces which have so far been used only very little in such machines. It has now been shown that for the use of an electric energy storage device, in particular the installation space below the maximum vertical height of the at least one drum becomes accessible for accommodating this energy storage device. This also improves the machine's center of gravity, as this installation space is comparatively low. This installation space may be used on either the front carriage or the rear frame or on both frame elements to accommodate one or more electric energy storage devices. Although the at least one electric energy storage device may be permanently installed in this region, it is ideal if there is additionally at least one access opening via which the at least one energy storage device can be accessed and replaced from the outside also in this frame region.

For lightweight, articulated tandem rollers in particular, it is further possible in cases where the operator platform is mounted on the rear carriage to use the region below the foot area of the operator sitting in a seat on the operator platform. On the one hand, this region is likewise characterized by a comparatively low position. On the other hand, the potentially available installation space in this region is comparatively large and easily accessible, so that an electric energy storage device with comparatively high storage capacity can be positioned very effectively in this region. It is further preferred if, in this region, a section of installation space is used which lies below the maximum vertical height of the drum (or the rubber wheel set) on the rear carriage. It is further possible if an access flap is provided in the floor panel of the operator platform to allow access to the electric energy storage device installed below this floor panel.

One aspect of the present invention is further achieved with a method for operating a ground compaction machine, in particular a ground compaction machine as described above. All features, advantages and effects of the ground compaction machine according to one embodiment of the present invention apply mutatis mutandis to the method according to the present invention, and therefore reference is made to the description of the ground compaction machine to avoid repetition. The method according to one embodiment of the present invention comprises the step of driving, in particular exclusively driving, at least one travel unit and/or the steering and/or a vibratory drive of the ground compaction machine via an electric motor. As already described with regard to the ground compaction machine, said driving may be affected via the electric motor, for example, in such a way that the electric motor drives a hydraulic pump, which in turn drives a hydraulic motor of the travel drive, the steering drive or the vibratory drive. The electric motor may directly cause the movement of the travel unit, the steering, or the vibration exciter, thus dispensing with a hydraulic system.

For the method as well, the entire ground compaction machine may be driven exclusively by electric motors, i.e., if the ground compaction machine is operated using neither combustion engines nor hydraulics or hydraulic systems. As already described, embodiments of the method comprise all embodiments of the ground compaction machine, and, in particular, exciting a vibration in a wheel or a roller drum via an electric motor, in particular arranged inside the wheel or inside the roller drum; and/or operating an electric motor inside a wheel or a roller drum by means of an electric energy storage device also arranged inside the wheel or inside the roller drum; and/or braking a vibratory drive inside a wheel or a roller drum via an electric motor, in particular with recovery of electric energy during braking; and/or charging at least one electric energy storage device via recovery of electric energy during braking and/or solar cells and/or a fuel cell and/or an external power source. The method according to the present invention likewise leads to a more efficient and cleaner operation of the ground compaction machine.

### BRIEF DESCRIPTION OF THE DRAWINGS

The present invention will be explained in more detail below by reference to the embodiment examples shown in the figures. In the schematic figures:

FIG. 1 shows a ground compaction machine configured as a tandem roller;

FIG. 2 shows a ground compaction machine configured as a single-drum roller;

FIG. 3 shows a ground compaction machine configured as a rubber-wheeled roller;

FIG. 4 shows a ground compaction machine configured as a trench roller;

FIG. 5 is a flow chart of the method; and

FIG. 6 shows a ground compaction machine configured as a lightweight tandem roller.

Like components or components acting in a like manner are designated by like reference numerals in the figures. Recurring parts are not designated separately in each figure.

### DETAILED DESCRIPTION OF THE INVENTION

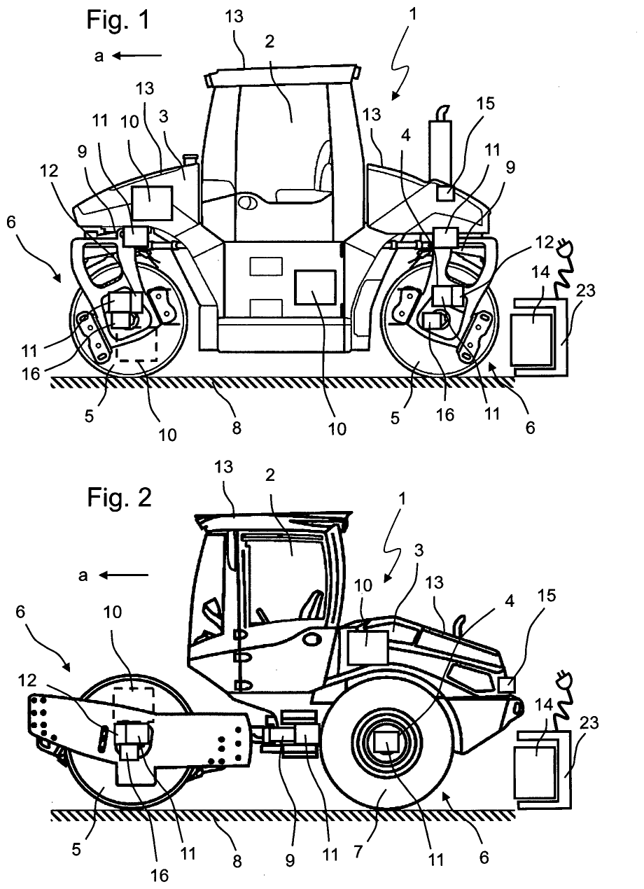

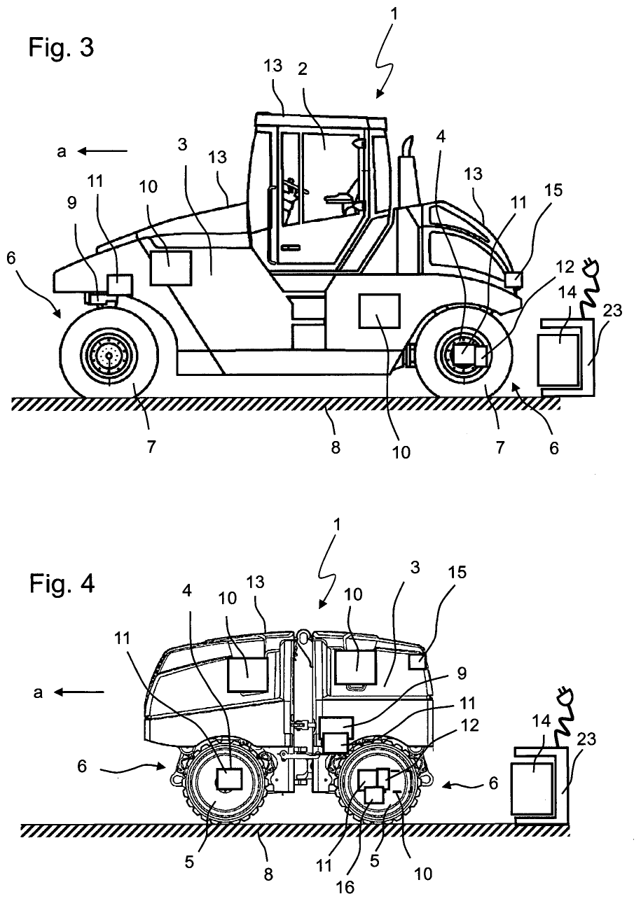

FIGS. 1 to 4 and 6 show ground compaction machines 1 according to the present invention, with FIG. 1 illustrating a tandem roller, FIG. 2 illustrating a single drum roller, FIG. 3 illustrating a rubber-wheeled roller, FIG. 4 illustrating a trench roller, and FIG. 6 illustrating a lightweight tandem roller. Although some of the figures show, for example, exhaust systems or exhausts, these figures obviously also schematically illustrate those embodiments in which combustion engines are dispensed with. The ground compaction machines 1 may comprise a machine frame 3 and travel units 6, which are configured as roller drums 5 or as wheels 7. During working operation, the ground compaction machines 1 travel in working direction a over a ground 8 to be compacted using the travel units 6. The working direction a is in this case selected as the forward direction, although the ground compaction machines 1 can obviously also compact the ground 8 in reverse, i.e., against the working direction a. The ground compaction machines 1 of FIGS. 1 to 3 also have an operator platform 2 in which an operator may be located to control the ground compaction machine 1. The trench roller of FIG. 4, on the other hand, does not have an operator platform 2 as it is a remote-controlled unit.

Travel drives 4 are provided on the travel units 6 for driving the travel units 6 and thus for locomotion of the ground compaction machines 1. For example, each travel unit 6 may be provided with a travel drive 4 provided for that travel unit 6. Moreover, steering drives 9 are provided on each of the steerable travel units 6 of the tandem roller according to FIG. 1 and the rubber-wheeled roller according to FIG. 3, which drive a steering movement of the travel units 6 in accordance with the control commands of an operator. The single-drum roller according to FIG. 2 and the trench roller according to FIG. 4, on the other hand, have an articulated joint via which the ground compaction machine 1 is steered. In these machines, the steering drive 9 is located at the articulated joint and drives a swiveling of the front and rear machine parts and, in particular, of the travel units 6 for steering the ground compaction machine 1. Moreover, vibratory drives 16 are typically provided inside the roller drums 5 of the ground compaction machines 1, which are configured to rotate vibration exciters that excite vibration of the roller drums 5, thereby improving compaction of the ground 8.

Typically, all of the travel drive 4, the steering drive 9 and the vibratory drive 16 are hydraulic drives, such as hydraulic motors, which are operated by a hydraulic pump located elsewhere on the ground compaction machine 1. According to a first embodiment of the present invention, these hydraulic pumps are now driven by at least one electric motor 11. Said at least one electric motor 11 is supplied with electric energy by an internal combustion engine, in particular a diesel internal combustion engine, via a generator, for example. According to one embodiment of the present invention, an electric energy storage device 10 is interposed between the generator and the at least one electric motor 11, which is charged by the generator and which supplies the electric motor 11 with electric energy. In this embodiment, the internal combustion engine can always be operated at the same, preferably optimum, power point and constantly charge the electric energy storage device 10 via the generator. Power peaks incurred at the electric motor 11 are compensated for by the energy stored in the electric energy storage device, so that the speed of the internal combustion engine does not need to be changed throughout working operation. This can significantly improve operational efficiency of the internal combustion engine.

According to an alternative embodiment of the present invention, the ground compaction machine 1 does not have an internal combustion engine, i.e., is configured without an internal combustion engine. For operating the at least one electric motor 11, at least one, in particular multiple, electric energy storage devices 10 are provided, which are configured, for example, as rechargeable accumulators or batteries. In this embodiment, too, the at least one electric motor 11 drives at least one hydraulic pump, which in turn supplies hydraulic energy to the likewise hydraulic travel drive 4, the steering drive 9 and the vibratory drive 16.

According to another embodiment of the present invention, the ground compaction machine 1 no longer has a hydraulic system, i.e., operates without hydraulics or a hydraulic system. In this case, the travel drive(s) 4, the steering drive(s) 9, and the vibratory drive(s) 16 each may comprise an electric motor 11 that performs the function of the respective drives. Thus, in this case, the electric motor 11 replaces the conventional hydraulic motor of the hydraulic system. The electric motor 11 therefore directly drives, for example, the rotation of the travel units 6, the steering movement of the steering drive 9 and the vibration exciter of the vibratory drive 16. In a first variant of this embodiment, an internal combustion engine is nevertheless still present, which provides the electric energy for the electric motor(s) 11 via a generator with interposition of an electric energy storage device 10. In a second and preferred variant of this embodiment, however, the ground compaction machine 1 is configured without hydraulics or an internal combustion engine. It therefore has neither an internal combustion engine nor a hydraulic system. All functions of the ground compaction machine 1 are performed by the least one electric motor 11 and, in particular, multiple electric motors 11. In this manner, the variety of parts of the ground compaction machine 1 is significantly reduced, which simplifies manufacturing and maintenance. Dispensing with an internal combustion engine and also dispensing with the hydraulic system makes considerable installation space available, which can be used to arrange electric energy storage devices 10.

It is particularly advantageous if the entire installation space made available on the ground compaction machine 1 is used for the arrangement of electric energy storage devices 10. For example, a plurality of electric energy storage devices 10 of different shapes and different sizes may be arranged at different positions on the ground compaction machine 1, for example in the storage space conventionally used as the engine compartment and/or also, for example, in the interior of the roller drum 5. By using electric energy storage devices 10 of different shapes, the shape of the electric energy storage device 10 can be adapted to the particular mounting location. Even angled, flat or small open spaces can thus be utilized to an optimum extent. For this purpose, for example, individual cells of the accumulators are arranged differently to each other and are soldered together. To increase the shock resistance of the electric energy storage device 10, a flexible or elastic solder is used and/or current-conducting elastic connecting elements are used for the current-conducting connection of individual battery cells, which have, for example, an elastic polymer and current-conducting particles dispersed therein.

The vibratory drive 16 typically drives a vibration exciter comprising rotating imbalance masses which, by their rotation, excite a vibration in the roller drum 5. When the vibratory drive 16 is switched off, the imbalance masses typically coast down for a longer time due to their inertia. In this case in particular, it is therefore advantageous to provide an electric brake 12 which, on the one hand, reduces the coast-down time of the vibratory drive 16, i.e., brakes the vibratory drive 16 or the imbalance masses as soon as the vibration operation has been switched off, and, on the other hand, recovers electric energy from the coast-down rotation of the imbalance masses. For example, the electric brake 12 is implemented such that the electric motor 11 used to drive the vibratory drive 16 also acts as a generator which recovers electric energy from the rotation of the imbalance masses and feeds it into the electric energy storage device 10. In this manner, the vibration exciter comes to a stop more quickly and operation is made more economical overall thanks to the recovered electric energy.

For further energy generation, solar cells 13 in the form of solar panels are preferably provided on the ground compaction machine 1. They are located, for example, on the roof of the operator platform 2 or at other locations on the external cladding of the ground compaction machine 1, for example on one or more hoods. Via the solar cells 13, the electric energy storage devices 10 can be charged during the entire working operation of the ground compaction machine 1, provided, of course, that work is carried out in daylight.

Moreover, a connector 15 for an external power source is provided on the ground compaction machine 1. The connector 15 on the ground compaction machine 1 may be in the form of a socket or a charging cable, for example. Via a complementary socket or a complementary charging cable, the ground compaction machine 1 can be connected to the general power grid via the connector 15, for example, via which the electric energy storage devices 10 can then be charged. Alternatively, it is also possible, for example, to use the connector 15 to connect the ground compaction machine 1 to an energy source, for example a fuel cell 14, from which it can be charged. In the shown embodiment examples of FIGS. 1 to 4, the fuel cell 14 together with its hydrogen tank is configured as part of a charging station 23, although the charging station may also comprise other energy sources. On the one hand, the charging station 23 has a receptacle for the fuel cell 14 and its hydrogen tank, so that the hydrogen tank, in particular, is shielded from environmental influences. In addition, the charging station has a device complementary to the connector 15 of the ground compaction machine 1, so that the charging station 23 can be electrically contacted with the ground compaction machine 1 such that the fuel cell 14 charges the electric energy storage devices 10 of the ground compaction machine 1. The charging station 23 is configured, in particular, as a mobile charging station and can be moved by an operator, for example manually. For this purpose, the charging station 23 also has wheels, for example.

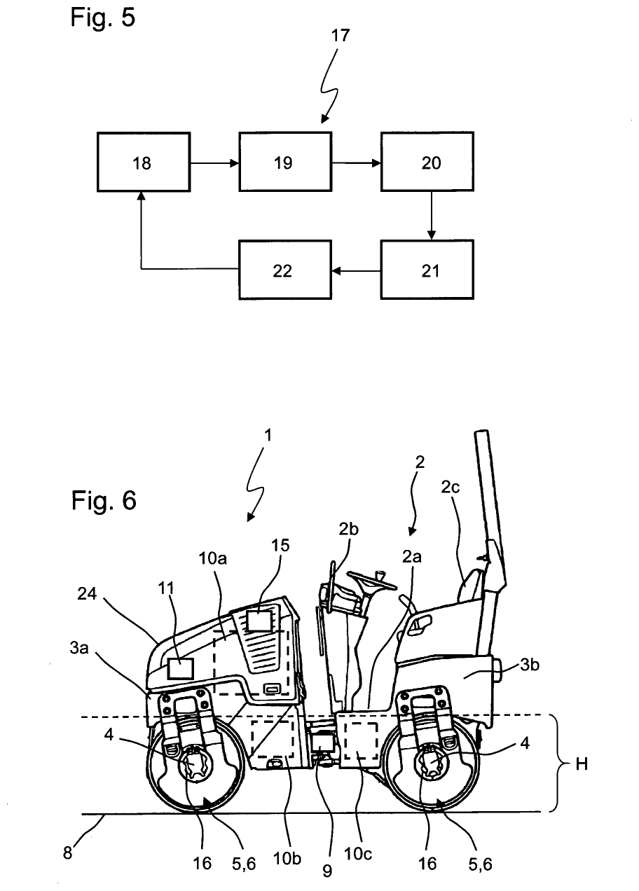

FIG. 5 shows the flowchart of the method 17. The method 17 starts with driving 18 at least one travel unit 6 and/or the steering and/or a vibratory drive 16 of the ground compaction machine 1 via an electric motor 11. In particular, the entire ground compaction machine 1 is driven 18 via electric motors 11. This means that the ground compaction machine 1 has neither an internal combustion engine nor hydraulics or a hydraulic system. This step is followed by exciting 19 a vibration in a wheel 7 or a roller drum 5 via an electric motor 11. The electric motor 11 is arranged, in particular, inside the wheel 7 or the roller drum 5. Operating 20 this electric motor 11 is, in particular, likewise performed by an electric energy storage device 10 arranged inside the wheel 7 or inside the roller drum 5. Braking 21 of a vibratory drive 16 inside the wheel 7 or inside the roller drum 5 is likewise performed via an electric motor 11, in particular with recovery of electric energy during braking 21. During working operation or also between working processes, charging 22 of at least one electric energy storage device 10 is performed via recovery of electric energy during braking and/or via solar cells 13 and/or via a fuel cell 14 and/or via another external power source. In addition, replaceable electric energy storage devices 10 may also be used, for example, so-called suitcase batteries. These may be charged in an external charging station 23 while the ground compaction machine 1 resumes operation with replaced electric energy storage devices 10. In this manner, downtimes for charging the electric energy storage devices 10 are avoided. All in all, therefore, the present invention makes it possible to operate the ground compaction machines 1 in an economical manner that also meets modern requirements regarding pollutant and noise emissions, and either reduces or even completely avoids the use of fossil fuels.

FIG. 6 shows a ground compaction apparatus 1 configured as a lightweight tandem roller. This class of ground compaction machines is characterized by a total weight of less than 5 t and is particularly suitable for the application of the concept described above. Generally, reference is made to the preceding description of the ground compaction machine 1. An essential characteristic of the lightweight tandem roller is, in particular, the structure consisting of a front frame 3a and a rear frame 3b, which are connected to one another in a manner known per se by means of an articulated joint. The operator platform 2, comprising a platform floor 2a, a steering column 2b and an operator seat 2c, is arranged on the rear carriage 3b. The platform floor 2a is located approximately at the height of the maximum vertical extension H (“upper apex”) of the two drums 6 or at the height of the highest point of one of the two drums 6, determined starting from the underlying ground 8 in the vertical direction to the upper apex of the drum 6 standing on the underlying ground. It is emphasized that the installation space within the machine frame 3 in the front carriage 3a and/or in the rear carriage 3b, which is below a virtual horizontal boundary line running through the maximum vertical extent H or the upper vertex of at least one of the two drums 6, can be used for at least partial and, in particular, at least complete accommodation of an electric energy storage device 10 (more specifically the electric energy storage devices 10b in the front carriage and 10c in the rear carriage). The special characteristic of the electric energy storage device 10c is that it is arranged on the rear carriage, in particular directly, below the platform floor 2a. The energy storage device 10b, on the other hand, is positioned in the front carriage. The energy storage device 10b and/or the energy storage device 10c is/are arranged in the respective region of the front carriage and/or the rear carriage that lies between the two drums in the traveling direction and below the maximum vertical extension of one of the two drums 6.

The tandem roller further comprise a hood 24 on the front carriage. Said hood can be swung open from the closed position shown in FIG. 6 to an open position. An electric energy storage device 10a arranged substantially above the virtual horizontal described above is arranged under the hood 24 as a supplement or alternative to the two energy storage devices 10b and 10c. The capacity of the latter is larger than that of the two energy storage devices 10b and/or 10c, but it may also comprise multiple subunits that can be replaced independently of one another. The hood 24 in this case provides for optimum access.

While various aspects in accordance with the principles of the present invention have been illustrated by the description of various embodiments, and while the embodiments have been described in considerable detail, they are not intended to restrict or in any way limit the scope of the present invention to such detail. The various features shown and described herein may be used alone or in any combination. Additional advantages and modifications will readily appear to those skilled in the art. The present invention in its broader aspects is therefore not limited to the specific details, representative apparatus and methods and illustrative examples shown and described. Accordingly, departures may be made from such details without departing from the scope of the general inventive concept.

What is claimed is:

1. A ground compaction machine for compacting a ground, comprising:
a machine frame;
at least one travel unit with a wheel or a roller drum;
a travel drive for driving the travel unit; and
a steering drive for adjusting the traveling direction of the ground compaction machine,
wherein the ground compaction machine comprises at least one electric motor.

2. The ground compaction machine according to claim 1,
wherein the ground compaction machine comprises at least one of the following features:
the at least one electric motor is configured to drive the travel drive and/or the steering drive;
the travel drive comprises an electric motor and is operated exclusively electrically;
the steering drive comprises an electric motor and is operated exclusively electrically; and/or
the ground compaction machine comprises a vibratory drive configured to excite a vibration at the wheel or roller drum, the vibratory drive comprising an electric motor and being operated exclusively electrically.

3. The ground compaction machine according to claim 2,
wherein the vibratory drive with the electric motor is arranged inside the wheel or the roller drum.

4. The ground compaction machine according to claim 2,
wherein the vibratory drive comprises an electric brake configured to shorten a coast-down time of the vibratory drive and to recover electric energy during braking.

5. The ground compaction machine according to claim 4,
wherein the electric brake comprises a capacitor configured such that the capacitor is chargeable during braking and the stored energy can be used to start the vibratory drive.

6. The ground compaction machine according to claim 2,
wherein the vibratory drive comprises a hydraulic energy storage device configured to shorten a coast-down time of the vibratory drive and to recover hydraulic energy during braking.

7. The ground compaction machine according to claim 1,
wherein the entire ground compaction machine is configured such that the ground compaction machine can be operated exclusively electrically via electric motors.

8. The ground compaction machine according to claim 1,
wherein the at least one electric motor is a synchronous motor and/or has water cooling.

9. The ground compaction machine according to claim 1,
wherein the ground compaction machine comprises at least two electric energy storage devices arranged separately from each other at different positions on the ground compaction machine.

10. The ground compaction machine according to claim 9,
wherein the electric energy storage devices are shock-resistant and/or are arranged on the ground compaction machine in a vibration-damped manner.

11. The ground compaction machine according to claim 9,
wherein at least one electric energy storage device is arranged inside the wheel or the roller drum.

12. The ground compaction machine according to claim 1,
wherein soldered connections of electric contacts for contacting the electric energy storage devices or their cells among each other, comprise an elastic solder.

13. The ground compaction machine according to claim 1,
wherein the ground compaction machine comprises at least one of the following features:
solar cells are provided on a roof of an operator platform and/or on a hood of the ground compaction machine which are configured to charge the at least two electric energy storage devices;
a mobile energy source, is provided which is configured to charge the at least two electric energy storage devices; and/or
a connector is provided which is configured such that an external power source can be connected to the ground compaction machine.

14. A method for operating a ground compaction machine according to claim 1, comprising the step of:
driving at least one travel unit and/or the steering and/or a vibratory drive of the ground compaction machine via an electric motor.

15. The method according to claim 14, characterized by at least one of the following steps:
exclusively driving the entire ground compaction machine via electric motors;
exciting a vibration in a wheel or a roller drum via an electric motor arranged inside the wheel or inside the roller drum;
operating an electric motor inside the wheel or the roller drum using an electric energy storage device also arranged inside the wheel or inside the roller drum;
braking a vibratory drive inside the wheel or the roller drum via an electric motor with recovery of electric energy during braking; and/or
charging at least one electric energy storage device via recovery of electric energy during braking and/or solar cells and/or a fuel cell and/or another external power source.

16. The ground compaction machine according to claim 1,
wherein the ground compaction machine comprises one of a tandem roller, a single-drum roller, a rubber-wheeled roller or a trench roller.
